(19) United States
(12) Patent Application Publication
(10) Pub. No.: US 2011/0267428 A1
(43) Pub. Date: Nov. 3, 2011

(54) SYSTEM AND METHOD FOR MAPPING A TWO-DIMENSIONAL IMAGE ONTO A THREE-DIMENSIONAL MODEL

(75) Inventors: Sheri George, Bangalore (IN); Nirm Velumylum Nirmalan, Niskayuna, NY (US); Anusha Rammohan, Bangalore (IN); Rajagopalan Chandrasekharan, Bangalore (IN); Mohamed Sakami, Clifton Park, NY (US)

(73) Assignee: General Electric Company, Schenectady, NY (US)

(21) Appl. No.: 12/771,929

(22) Filed: Apr. 30, 2010

(51) Int. Cl. H04N 13/02

(52) U.S. Cl. 348/46; 348/E13.074

(57) ABSTRACT

In one embodiment, a system includes a turbine comprising multiple components in fluid communication with a working fluid. The system also includes an imaging system in optical communication with at least one component. The imaging system is configured to receive a two-dimensional image of the at least one component during operation of the turbine, and to map the two-dimensional image onto a three-dimensional model of the at least one component to establish a composite model.

### BACKGROUND OF THE INVENTION

The subject matter disclosed herein relates to a system and method for mapping a two-dimensional image onto a three-dimensional model.

Certain gas turbine engines include a turbine having viewing ports configured to facilitate monitoring of various components within the turbine. For example, a pyrometry system may be in optical communication with the viewing ports and configured to measure the temperature of certain components within a hot gas path of the turbine. In addition, an optical monitoring system may be coupled to the viewing ports and configured to provide a two-dimensional image of the turbine components. Unfortunately, it may be difficult and time-consuming for an operator to correlate the position of a measured temperature and/or a two-dimensional image with a location on the actual components being monitored. Consequently, inaccurate component temperatures may be computed and/or the operator may be unable to detect minute defects within the turbine components.

### BRIEF DESCRIPTION OF THE INVENTION

In a first embodiment, a system includes a turbine and a viewing port into the turbine. The system also includes a camera in optical communication with the viewing port. The camera is configured to obtain a two-dimensional image of a component within the turbine. The system further includes a controller communicatively coupled to the camera and configured to map the two-dimensional image onto a three-dimensional model of the component to establish a composite model.

In a second embodiment, a system includes a turbine comprising multiple components in fluid communication with a working fluid. The system also includes an imaging system in optical communication with at least one component. The imaging system is configured to receive a two-dimensional image of the at least one component during operation of the turbine, and to map the two-dimensional image onto a three-dimensional model of the at least one component to establish a composite model.

In a third embodiment, a method includes receiving a two-dimensional image of a turbine component during operation of a turbine. The method also includes mapping the two-dimensional image onto a three-dimensional model of the turbine component to establish a composite model.

### BRIEF DESCRIPTION OF THE DRAWINGS

These and other features, aspects, and advantages of embodiments disclosed herein will become better understood when the following detailed description is read with reference to the accompanying drawings in which like characters represent like parts throughout the drawings, wherein:

FIG. 1 is a block diagram of a turbine system including an imaging system configured to map a two-dimensional image of a turbine component onto a three-dimensional model of the turbine component in accordance with certain disclosed embodiments;

FIG. 2 is a cross-sectional view of a turbine section, illustrating various turbine components that may be monitored by the imaging system in accordance with certain disclosed embodiments;

FIG. 3 is a schematic diagram of the imaging system shown in FIG. 1, including multiple cameras, a controller and a display configured to display the two-dimensional image mapped onto the three-dimensional model in accordance with certain disclosed embodiments;

FIG. 4 is a diagram illustrating an exemplary technique for mapping a two-dimensional image onto a two-dimensional projection of a three-dimensional model in accordance with certain disclosed embodiments;

FIG. 5 is a diagram illustrating misalignment between a second two-dimensional image and the two-dimensional projection of the three-dimensional model in accordance with certain disclosed embodiments; and

FIG. 6 is a flowchart of a method for mapping a two-dimensional image onto a three-dimensional model in accordance with certain disclosed embodiments.

### DETAILED DESCRIPTION OF THE INVENTION

One or more specific embodiments will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments disclosed herein, the articles “a,” “an,” “the,” and “said” are intended to mean that there are one or more of the elements. The terms “comprising,” “including,” and “having” are intended to be inclusive and mean that there may be additional elements other than the listed elements.

Embodiments disclosed herein may enhance turbine component inspection by providing an operator with a composite model of the turbine component. The composite model may include a two-dimensional image of the turbine component mapped onto a three-dimensional model of the component. In one embodiment, an imaging system includes a camera in optical communication with a viewing port into a turbine. The camera is configured to obtain a two-dimensional image of a component within the turbine. The imaging system also includes a controller communicatively coupled to the camera and configured to map the two-dimensional image onto a three-dimensional model of the component to establish a composite model. Because an operator may view the two-dimensional image mapped onto the three-dimensional model, the operator may easily associate elements of the image with locations on the turbine component. Consequently, the operator may be able to identify blocked cooling holes within turbine blades, measure dimensional variations between the three-dimensional model and the component, estimate the remaining life of the turbine component and/or determine a desired inspection interval. In addition, certain embodiments of the imaging system may be configured to compute a three-dimensional temperature profile based on a two-dimensional infrared image of the turbine component. Such embodiments may employ reflection analysis to accurately determine absolute temperature by compensating for radiation reflected from adjacent components. The resulting three-dimensional temperature profile may enable the operator to readily identify temperature variations across the surface of the turbine component.

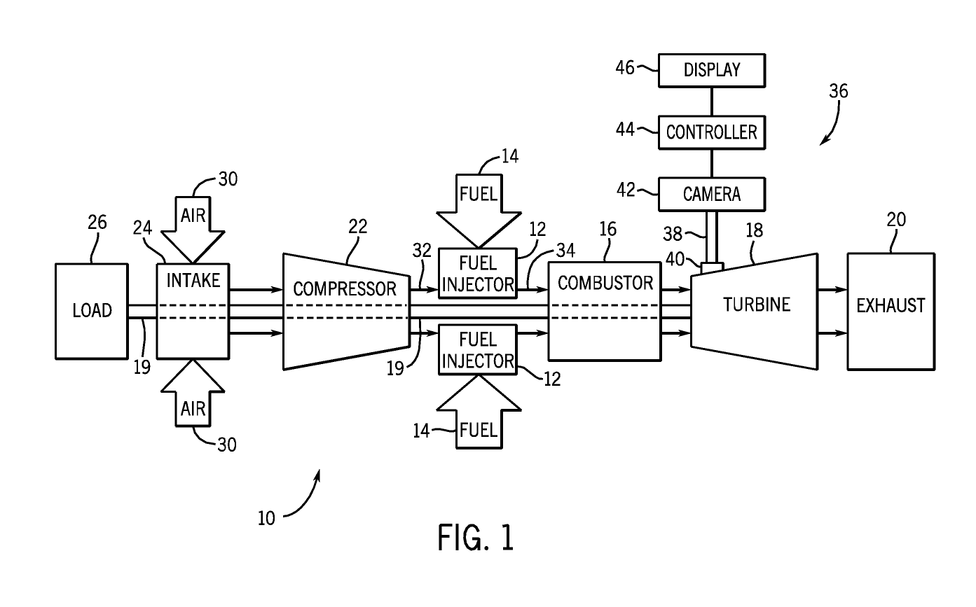

Turning now to the drawings, FIG. 1 is a block diagram of a turbine system 10 including an imaging system configured to map a two-dimensional image of a turbine component onto a three-dimensional model of the turbine component. The turbine system 10 includes a fuel injector 12, a fuel supply 14, and a combustor 16. As illustrated, the fuel supply 14 routes a liquid fuel and/or gas fuel, such as natural gas, to the gas turbine system 10 through the fuel injector 12 into the combustor 16. As discussed below, the fuel injector 12 is configured to inject and mix the fuel with compressed air. The combustor 16 ignites and combusts the fuel-air mixture, and then passes hot pressurized exhaust gas into a turbine 18. As will be appreciated, the turbine 18 includes one or more stators having fixed vanes or blades, and one or more rotors having blades which rotate relative to the stators. The exhaust gas passes through the turbine rotor blades, thereby driving the turbine rotor to rotate. Coupling between the turbine rotor and a shaft 19 will cause the rotation of the shaft 19, which is also coupled to several components throughout the gas turbine system 10, as illustrated. Eventually, the exhaust of the combustion process may exit the gas turbine system 10 via an exhaust outlet 20.

A compressor 22 includes blades rigidly mounted to a rotor which is driven to rotate by the shaft 19. As air passes through the rotating blades, air pressure increases, thereby providing the combustor 16 with sufficient air for proper combustion. The compressor 22 may intake air to the gas turbine system 10 via an air intake 24. Further, the shaft 19 may be coupled to a load 26, which may be powered via rotation of the shaft 19. As will be appreciated, the load 26 may be any suitable device that may use the power of the rotational output of the gas turbine system 10, such as a power generation plant or an external mechanical load. For example, the load 26 may include an electrical generator, a propeller of an airplane, and so forth. The air intake 24 draws air 30 into the gas turbine system 10 via a suitable mechanism, such as a cold air intake. The air 30 then flows through blades of the compressor 22, which provides compressed air 32 to the combustor 16. In particular, the fuel injector 12 may inject the compressed air 32 and fuel 14, as a fuel-air mixture 34, into the combustor 16. Alternatively, the compressed air 32 and fuel 14 may be injected directly into the combustor for mixing and combustion.

As illustrated, the turbine system 10 includes an imaging system 36 optically coupled to the turbine 18. In the illustrated embodiment, the imaging system 36 includes an optical connection 38 (e.g., fiber optic cable, optical waveguide, etc.) extending between a viewing port 40 into the turbine 18 and a camera 42. As discussed in detail below, the camera 42 is configured to obtain a two-dimensional image of a component within the turbine 18 through the viewing port 40. The camera 42 is communicatively coupled to a controller 44 which is configured to map the two-dimensional image onto a three-dimensional model of the component to establish a composite model. A two-dimensional projection of the composite model may be shown on a display 46 communicatively coupled to the controller 44. In certain embodiments, an operator may be able to rotate and/or translate the composite model shown on the display 46 via a user interface. In this manner, the operator may easily associate features shown in the two-dimensional image with positions on the turbine component. Consequently, the operator may be able to identify blocked cooling holes within turbine blades, measure dimensional variations between the three-dimensional model and the component, estimate the remaining life of the turbine component and/or determine a desired inspection interval. In addition, certain embodiments may employ a camera 42 having an image sensing device configured to detect infrared radiation emitted by the turbine component. In such embodiments, the controller 44 may be configured to compute a three-dimensional temperature profile based on the two-dimensional infrared image provided by the camera 42. Consequently, the operator may readily identify temperature variations across the surface of the turbine component.

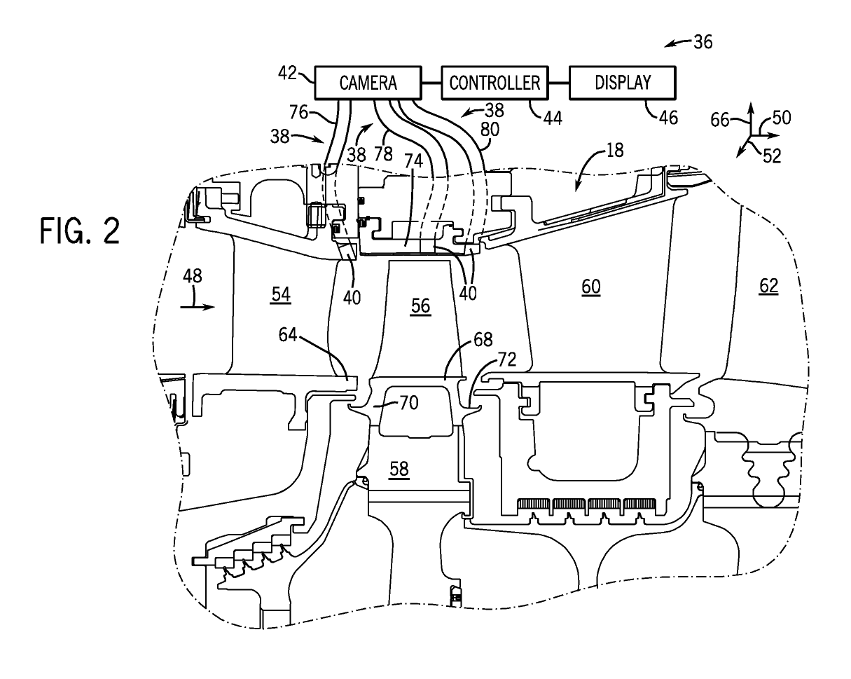

FIG. 2 is a cross-sectional view of a turbine section, illustrating various turbine components that may be monitored by the imaging system 36. As illustrated, exhaust gas 48 from the combustor 16 flows into the turbine 18 in an axial direction 50 and/or a circumferential direction 52. The illustrated turbine 18 includes at least two stages, with the first two stages shown in FIG. 2. Other turbine configurations may include more or fewer turbine stages. For example, a turbine may include 1, 2, 3, 4, 5, 6, or more turbine stages. The first turbine stage includes vanes 54 and blades 56 substantially equally spaced in the circumferential direction 52 about the turbine 18. The first stage vanes 54 are rigidly mounted to the turbine 18 and configured to direct combustion gases toward the blades 56. The first stage blades 56 are mounted to a rotor 58 that is driven to rotate by the exhaust gas 48 flowing through the blades 56. The rotor 58, in turn, is coupled to the shaft 19, which drives the compressor 22 and the load 26. The exhaust gas 48 then flows through second stage vanes 60 and second stage blades 62. The second stage blades 62 are also coupled to the rotor 58. As the exhaust gas 48 flows through each stage, energy from the gas is converted into rotational energy of the rotor 58. After passing through each turbine stage, the exhaust gas 48 exits the turbine 18 in the axial direction 50.

In the illustrated embodiment, each first stage vane 54 extends outward from an endwall 64 in a radial direction 66. The endwall 64 is configured to block hot exhaust gas 48 from entering the rotor 58. A similar endwall may be present adjacent to the second stage vanes 60, and subsequent downstream vanes, if present. Similarly, each first stage blade 56 extends outward from a platform 68 in the radial direction 66. As will be appreciated, the platform 68 is part of a shank 70 which couples the blade 56 to the rotor 58. The shank 70 also includes a seal, or angel wing, 72 configured to block hot exhaust gas 48 from entering the rotor 58. Similar platforms and angel wings may be present adjacent to the second stage blades 62, and subsequent downstream blades, if present. Furthermore, a shroud 74 is positioned radially outward from the first stage blades 56. The shroud 74 is configured to minimize the quantity of exhaust gas 48 that bypasses the blades 56. Gas bypass is undesirable because energy from the bypassing gas is not captured by the blades 56 and translated into rotational energy. While embodiments of the imaging system 36 are described below with reference to monitoring components within the turbine 18 of a gas turbine engine 10, it should be appreciated that the imaging system 36 may be employed to monitor components within other rotating and/or reciprocating machinery, such as a turbine in which steam or another working fluid passes through turbine blades.

As will be appreciated, various components within the turbine 18 (e.g., vanes 54 and 60, blades 56 and 62, endwalls 64, platforms 68, angel wings 72, shrouds 74, etc.) will be exposed to the hot exhaust gas 48 from the combustor 16. Consequently, it may be desirable to measure a temperature of certain components during operation of the turbine 18 to ensure that the temperature remains within a desired range and/or to monitor thermal stress within the components. For example, the imaging system 36 may be configured to capture a two-dimensional infrared image of the first stage turbine blades 56. The two-dimensional infrared image may then be used to compute a three-dimensional temperature profile such that an operator may identify temperature variations across the surface of the blades 56. In addition, two-dimensional images of the turbine blades 56 may be mapped onto the three-dimensional model of the blades to provide an operator with a visual indication of blocked cooling holes and/or other turbine blade defects.

As illustrated, the imaging system 36 includes three viewing ports 40 directed toward different regions of the blade 56. Three optical connections 38 optically couple the viewing ports 40 to the camera 42. A first optical connection 76 is configured to convey an image of an upstream portion of the blade 56 to the camera 42, a second optical connection 78 is configured to convey an image of a circumferential side of the blade 56 to the camera 42, and a third optical connection 80 is configured to convey an image of a downstream portion of the blade 56 to the camera 42. The viewing ports 40 may be angled in the axial direction 50, circumferential direction 52 and/or radial direction 66 to direct the viewing ports 40 toward desired regions of the blade 56. In alternative embodiments, more or fewer viewing ports 40 and optical connections 38 may be employed to obtain images of the first stage blade 56. For example, certain embodiments may employ 1, 2, 3, 4, 5, 6, 7, 8, or more viewing ports 40 and a corresponding number of optical connections 38 to convey images of the blade 56 to the camera 42. As will be appreciated, the more viewing ports 40 and optical connections 38 employed, the more regions of the blade 56 that may be monitored. As previously discussed, the optical connections 38 may include a fiber optic cable or an optical waveguide, for example. It should also be appreciated that certain embodiments may omit the optical connections 38, and the camera 42 may be directly optically coupled to the viewing ports 40.

While the viewing ports 40 are directed toward the first stage blades 56 in the illustrated embodiment, it should be appreciated that the viewing ports 40 may be directed toward other turbine components in alternative embodiments. For example, one or more viewing ports 40 may be directed toward the first stage vanes 54, the second stage vanes 60, the second stage blades 62, the endwalls 64, the platforms 68, the angel wings 72, the shrouds 74, or other components within the turbine 18. Further embodiments may include viewing ports 40 directed toward multiple components within the turbine 18. Similar to the first stage blades 56, the imaging system 36 may capture a two-dimensional image of each component within a field of view of a viewing port 40, and map the two-dimensional image onto a respective three-dimensional model. In this manner, an operator may readily associate elements of each image with locations on the respective turbine component.

As previously discussed, the optical connections 38 (e.g., fiber optic cable, optical waveguide, etc.) convey an image from the turbine 18 to the camera 42. The camera 42 may be configured to capture multiple images over a period of time. As will be appreciated, certain turbine components, such as the first stage blades 56 described above, may rotate at high speed along the circumferential direction 52 of the turbine 18. Consequently, to capture an image of such components, the camera 42 may be configured to operate at an integration time sufficient to provide the controller 44 with a substantially still image of each component. For example, in certain embodiments, the camera 42 may be configured to output a signal indicative of the two-dimensional image of the turbine component with an integration time shorter than approximately 10, 5, 3, 2, 1, or 0.5 microseconds, or less. In this manner, the controller 44 may map each two-dimensional image onto a three-dimensional model of the turbine component. For example, the imaging system 36 may be configured to capture a two-dimensional image of each first stage turbine blade 56 as the blades rotate. The images may then be mapped onto a three-dimensional model of the blade, thereby establishing a composite model for each blade 56 within the turbine 18.

In certain embodiments, the optical connections 38 may be coupled to a multiplexer within the camera 42 to facilitate monitoring images from each observation point. As will be appreciated, images from each optical connection 38 may be multiplexed in space or time. For example, if the multiplexer is configured to multiplex the images in space, each image may be projected onto a different portion of an image sensing device (e.g., charge-coupled device (CCD), complementary metal oxide semiconductor (CMOS), etc.) within the camera 42. In this configuration, an image from the first optical connection 76 may be directed toward an upper portion of the image sensing device, an image from the second optical connection 78 may be directed toward a central portion of the image sensing device, and an image from the third optical connection 80 may be directed toward a lower portion of the image sensing device. As a result, the image sensing device may scan each image at one-third resolution. In other words, scan resolution is inversely proportional to the number of spatially multiplexed signals. As will be appreciated, lower resolution scans provide the controller 44 with less information about the turbine component than higher resolution scans. Therefore, the number of spatially multiplexed signals may be limited by the minimum resolution sufficient for the controller 44 to establish a desired two-dimensional image of the turbine component.

Alternatively, images provided by the optical connections 38 may be multiplexed in time. For example, the camera 42 may alternately scan an image from each optical connection 38 using the entire resolution of the image sensing device. Using this technique, the full resolution of the image sensing device may be utilized, but the scanning frequency may be reduced proportionally to the number of observation points scanned. For example, if two observation points are scanned and the image sensing device frequency is 100 Hz, the camera 42 is only able to scan images from each observation point at 50 Hz. Therefore, the number of temporally multiplexed signals may be limited by the desired scanning frequency.

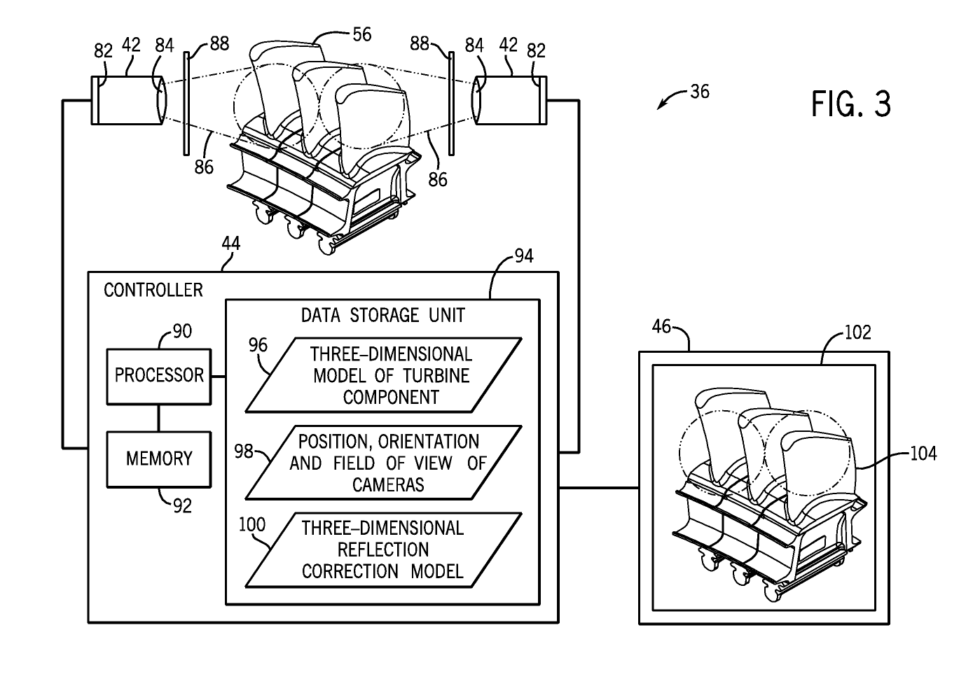

FIG. 3 is a schematic diagram of the imaging system 36 shown in FIG. 1, including multiple cameras 42, the controller 44 and the display 46 configured to display a two-dimensional image mapped onto a three-dimensional model. As illustrated, each camera 42 includes an image sensing device 82 configured to convert radiation emitted and reflected by the turbine components into an electrical signal for processing by the controller 44. As will be appreciated, the image sensing device 82 may be a charge-coupled device (CCD), a complementary metal oxide semiconductor (CMOS), a focal plane array (FPA), or any other suitable device for converting electromagnetic radiation into an electrical signal. In the illustrated embodiment, two cameras 42 are directed toward different regions of the first stage blades 56. However, it should be appreciated that the cameras 42 may be directed toward other turbine components (e.g., vanes 54 and 60, blades 62, endwalls 64, platforms 68, angel wings 72, shrouds 74, etc.) in alternative embodiments. In addition, more or fewer cameras 42 may be utilized in alternative embodiments. For example, in certain embodiments 1, 2, 3, 4, 5, 6, 7, 8, or more cameras 42 may be directed toward the blades 56. As previously discussed, further embodiments may include multiple optical connections 38 extending between the turbine 18 and a multiplexer within each camera 42.

In the illustrated embodiment, the image sensing device 82 is configured to monitor infrared radiation. For example, the image sensing device 82 may be sensitive to wavelengths ranging approximately from 900 to 1700 nm. As will be appreciated, alternative image sensing devices 82 may be sensitive to other wavelength ranges within the infrared spectrum, such as wavelengths approximately between 750 nm to 15 μm. Further embodiments may employ image sensing devices 82 sensitive to visible light and/or ultraviolet wavelengths. Yet further embodiments may utilize image sensing devices 82 configured to monitor X-ray or ultrasonic wavelengths, among other acoustic and/or electromagnetic wavelengths.

Each camera 42 also includes a lens 84 configured to focus the radiation received from the blades 56 onto the image sensing device 82. As will be appreciated, the lens 84, or series of lenses 84, will establish a field of view 86 covering at least a portion of the first stage blades 56, or other desired turbine components. The field of view 86 will also be affected by the position of the camera 42 relative to the turbine component and/or the configuration of the optical connection 38, if present. By selecting an appropriate lens 84 and/or properly positioning the camera 42, a desired field of view 86 may be established, thereby enabling the camera 42 to capture a two-dimensional image of the turbine component. In the illustrated embodiment, a filter 88 is disposed between the camera 42 and the first stage blades 56. The filter 88 may be a low-pass filter, a high-pass filter or a band-pass filter configured to reduce the wavelength range of radiation received by the image sensing device 82. For example, the filter 88 may be configured to facilitate passage of radiation having a wavelength range approximately between 1500 nm to 1700 nm. Such a wavelength range may be well-suited for turbine component temperature measurement. In alternative embodiments, the filter 88 may be omitted or combined with the lens 84.

As previously discussed, the cameras 42 are communicatively coupled to the controller 44. As illustrated, the controller 44 includes a processor 90, a memory 92 and a data storage unit 94. The processor 90 is configured to receive a signal indicative of the two-dimensional image of the turbine component, and to map the two-dimensional image onto a three-dimensional model of the component. The memory 92 may include instructions associated with the mapping process and/or may serve as a temporary storage location. As illustrated, the data storage unit 94 includes a three-dimensional model of the turbine component, as represented by block 96, data indicative of position, orientation and field of view of the cameras 42, as represented by block 98, and a three-dimensional reflection correction model, as represented by block 100. As discussed in detail below, the information contained within the data storage unit 94 may be utilized to map a two-dimensional image onto the three-dimensional model to visualize operational characteristics (e.g., temperature, blocked cooling holes, dimensional variations, etc.) of the turbine component.

The three dimensional model of the turbine component contained within the data storage unit 94 is a numerical representation of the turbine component monitored by the cameras 42. For example, in the illustrated embodiment, the three-dimensional model will be a model of the first stage turbine blades 56. However, if other components within the turbine 18 (e.g., vanes 54 and 60, blades 62, endwalls 64, platforms 68, angel wings 72, shrouds 74, etc.) are being monitored, the data storage unit 94 will contain a model of the monitored component. In certain embodiments, the three-dimensional model may be a computer-aided design (CAD) file used for design and/or manufacture of the turbine component. In such embodiments, the three-dimensional model may substantially correspond to the initial structure of the turbine component. Consequently, the process of mapping the two-dimensional image onto the three-dimensional model may reveal dimensional variations between the initial state of the component and the current operating state, thereby facilitating computation of internal stress within the component.

The position, orientation and field of view data for each camera 42 or view port 40 may be utilized to establish a two-dimensional projection of the three-dimensional model which corresponds to the view from each camera 42. Consequently, a two-dimensional projection will be created which substantially matches the two-dimensional image from the camera 42. As discussed in detail below, the processor 90 will determine a transformation by mapping the two-dimensional image onto the two-dimensional projection of the three-dimensional model. Next, the processor 90 will apply the transformation to the two-dimensional image to establish a transformed image. The transformed image will then be applied to the three-dimensional model, thereby establishing a composite model including a two-dimensional image of the actual turbine component mapped onto the numerical representation of the component.

The procedure described above may be repeated for each camera 42 monitoring the turbine component. In the illustrated embodiment, each camera 42 is directed toward a different region of the first stage turbine blades 56. Consequently, a two-dimensional image of each region may be mapped onto the three-dimensional model, thereby providing increased image coverage across the surface of the composite model. As will be appreciated, additional cameras 42 may be directed toward the turbine component from different angles to monitor additional regions of the component, thereby further increasing coverage of the displayed image. In embodiments where the monitored regions overlap, the processor 90 may be configured to automatically blend the overlapping images. As illustrated, the display 46 is communicatively coupled to the controller 44. The display 46 includes a viewing area 102 configured to display a two-dimensional representation of the composite model 104. In certain embodiments, the display 46 may be connected to a user interface configured to facilitate rotation and/or translation of the composite model 104 on the viewing area 102. For example, the model 104 may be oriented to examine particular areas of the turbine component to identify blocked cooling holes, cracks, deformations and/or other anomalies that may be present within the turbine component. Because the two-dimensional image of the turbine component is mapped onto the composite model, an operator may detect the presence and/or location of defects more rapidly than observing a two-dimensional image, thereby increasing efficiency of the inspection process.

As previously discussed, the data storage unit 94 also includes a three-dimensional reflection correction model, as represented by block 100. The model 100 may be used to generate an accurate temperature profile across the surface of the turbine component. In the illustrated embodiment, the cameras 42 are configured to monitor radiation received from the turbine component within the infrared spectrum.

As will be appreciated, infrared emissions may be used to determine a temperature profile across the component. For example, assuming emissivity is one (Black Body assumption), Planck's Law may be utilized to compute temperature from a measured radiation intensity. However, emissivity may vary based on a number of factors including temperature and wavelength. In addition, radiation may be reflected from surrounding components, thereby increasing the intensity of the radiation emitted from a particular area of the monitored component. Consequently, the processor 90 may be configured to compute a three-dimensional temperature profile based on the two-dimensional infrared image and the three-dimensional reflection correction model 100. As will be appreciated, because the reflected signal is at least partially dependent upon the location of the measured radiation, such a computation may be performed after the two-dimensional image is mapped onto the three-dimensional model. In this manner, reflected radiation may be computed and subtracted from the detected radiation intensity, thereby resulting in a more accurate temperature measurement than configurations which adjust the radiation intensity based on a two-dimensional model. Once computed, the three-dimensional temperature profile may be shown on the display 46.

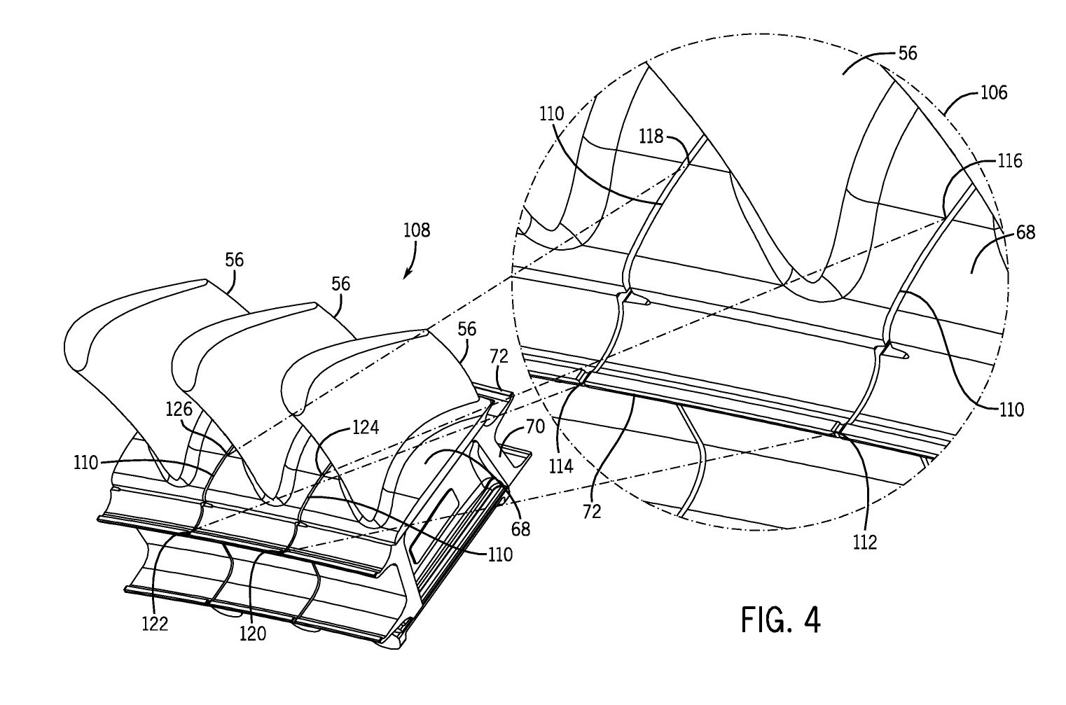

FIG. 4 is a diagram illustrating an exemplary technique for mapping a two-dimensional image onto a two-dimensional projection of a three-dimensional model. As previously discussed, the process of applying the two-dimensional image onto the three-dimensional model begins with determining a transformation by mapping the two-dimensional image onto a two-dimensional projection of the three-dimensional model. In the illustrated embodiment, the process of determining the transformation includes aligning multiple reference points on the two-dimensional image with corresponding points on the two-dimensional projection of the three-dimensional model, and establishing a bilinear transformation based on the alignment. As illustrated, reference points of a two-dimensional image 106 of turbine blades 56 and platforms 68 are aligned with corresponding points of a two-dimensional projection 108 of a three-dimensional model of the monitored components. In the illustrated embodiment, the reference points are positioned along slash faces 110 of the platforms 68. However, it should be appreciated that the reference points may be located within other areas of the turbine component in alternative embodiments.

As illustrated, the two-dimensional image 106 includes a first reference point 112 positioned along a first slash face 110 at a tip of the angel wing 72, a second reference point 114 positioned along a second slash face 110 at a tip of the angel wing 72, a third reference point 116 positioned along the first slash face 110 at an inflection in the platform 68, and a fourth reference point 118 positioned along the second slash face 110 at an inflection in the platform 68. To establish the bilinear transformation, the first reference point 112 may be aligned with a first corresponding point 120 on the two-dimensional projection 108, the second reference point 114 may be aligned with a second corresponding point 122, the third reference point 116 may be aligned with a third corresponding point 124, and the fourth reference point 118 may be aligned with a fourth corresponding point 126. While four points are aligned in the illustrated embodiment, it should be appreciated that more points may be utilized in alternative embodiments. For example, certain embodiments may include 4, 5, 6, 7, 8, 9, 10, or more points to facilitate computation of the bilinear transformation.

By measuring the two-dimensional position of each reference point on the two-dimensional image 106 and each corresponding point on the two-dimensional projection 108 of the three-dimensional model, a bilinear transformation may be computed. As will be appreciated, a bilinear transformation may be calculated based on the following equations:

u=a₀+a₁x+a₂y+a₃xy

v=b₀+b₁x+b₂y+b₃xy

where (x, y) are the coordinates of each point on the two-dimensional image 106, (u, v) are the coordinates of each point on the two-dimensional projection 108 of the three-dimensional model, and a₀, a₁, a₂, a₃, b₀, b₁, b₂ and b₃ are parameters which define the bilinear transformation. Because the illustrated embodiment maps four reference points of the two-dimensional image 106 onto four corresponding points on the two-dimensional projection 108 of the three-dimensional model, a total of eight equations (i.e., two for each point) will be generated based on the above set of equations. As a result, the eight equations may be solved for the eight parameters (a₀, a₁, a₂, a₃, bₒ, b₁, b₂ and b₃) which define the bilinear transformation. If more than four points are utilized, a least squares method may be employed to determine the eight parameters.

Once the bilinear transformation is computed, the transformation may be applied to the two-dimensional image 106 to establish a transformed image. For example, the position (e.g., (x, y) coordinates) of each point (e.g., pixel) on the two-dimensional image 106 may be transformed into a position (e.g., (u, v) coordinates) of a corresponding point on the transformed image via the above equations. While the illustrated embodiment utilizes a bilinear transformation, it should be appreciated that alternative embodiments may employ other transformations (e.g., affine, Procrustes, perspective, polynomial, etc.) to map the two-dimensional image 106 onto the two-dimensional projection 108 of the three-dimensional model.

The transformed image may then be applied to the three-dimensional model to establish the composite model. For example, the illustrated embodiment may utilize an inverse perspective transformation to map the transformed image onto the three-dimensional model. As will be appreciated, the three-dimensional model includes a series of vertices or nodes which define the shape of the turbine component. The position of each node within the two-dimensional projection 108 of the three-dimensional model may be computed based on the position, orientation and field of view of the projection 108. Because the coordinates of the transformed image substantially correspond to the coordinates of the two-dimensional projection 108, the nodes of the transformed image may be aligned with the nodes of the three-dimensional model via the inverse perspective transform. The transformed image may then be mapped onto the three-dimensional model, thereby establishing the composite model. As will be appreciated, other transformations, such as an inverse orthogonal projection, may be utilized to apply the transformed image onto the three-dimensional model.

In addition, while the mapping process described above maps the two-dimensional image 106 onto the three-dimensional model, it should be appreciated that processed images, such as a two-dimensional temperature distribution or a visually enhanced image, may be mapped onto the three-dimensional model in a similar manner. For example, the two-dimensional image 106 may be visually enhanced by increasing the brightness, sharpening the image, increasing contrast and/or other image processing techniques. In certain embodiments, information related to the nodes of the three-dimensional model may be employed to generate the processed image. Once mapped onto the three-dimensional model, the processed image may enable the operator to identify blocked cooling holes and/or other anomalies more rapidly than configurations which directly map the image 106 onto the three-dimensional model. Consequently, the operator may be able to efficiently estimate the remaining operation life of the component and/or determine a desired inspection interval.

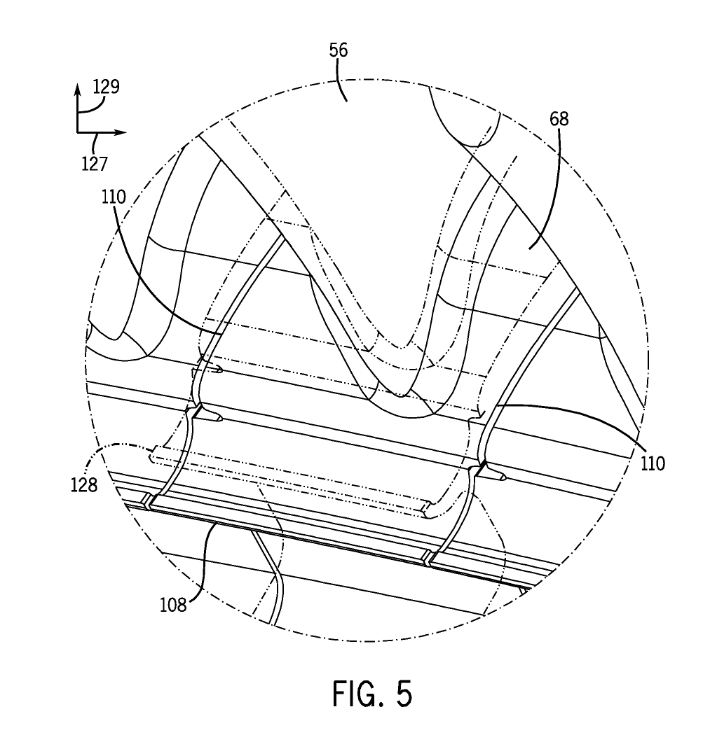

FIG. 5 is a diagram illustrating misalignment between a second two-dimensional image and the two-dimensional projection of the three-dimensional model. In the illustrated embodiment, the imaging system 36 is configured to capture images of first stage turbine blades 56 as the blades 56 rotate along the circumferential direction 52. Because the blades 56 rotate, a camera 42 coupled to a fixed viewing port 40 may capture an image of each blade 56 as the blade 56 passes within the field of view 86 of the camera 42. Because each first stage blade 56 may have substantially similar geometry, a single three-dimensional model may be utilized for each blade 56. Consequently, the computed bilinear transformation between the two-dimensional image 106 and the two-dimensional projection 108 of the three-dimensional model may be applied to each turbine blade image. For example, the transformation may be applied to a second two-dimensional image to establish a second transformed image.

However, it should be appreciated that the second transformed image may not properly align with the two-dimensional projection 108 of the three-dimensional model. For example, the illustrated second transformed image 128 (phantom lines) is offset from the two-dimensional projection 108 (solid lines) along the orthogonal axes. The offset or misalignment may be the result of turbine vibration and/or rotation of blade tips relative to one another, a condition which may be known as “jitter.” For example, turbine vibration may induce an offset between the second transformed image 128 and the two-dimensional projection 108 along a lateral axis 127 and/or a longitudinal axis 129. In addition, the jitter may cause a rotational and/or shearing misalignment between the images. As a result of the offset between images, it may be desirable to align the second transformed image 128 with the two-dimensional projection 108 of the three-dimensional model prior to applying the second transformed image 128 to the three-dimensional model.

As will be appreciated, a variety of techniques may be employed to align the second transformed image 128 with the two-dimensional projection 108. For example, in certain embodiments cross-correlation may be used to compensate for the offset in the lateral direction 127 and/or longitudinal direction 129 caused by turbine vibration. As will be appreciated, cross-correlation involves computing a cross-correlation matrix based on the second transformed image 128 and the two-dimensional projection 108. As will be further appreciated, a maximum value of the cross-correlation matrix may correspond to the two-dimensional, linear offset between the images. Consequently, by applying the computed offset to the second transformed image 128, the second transformed image 128 may be aligned with the two-dimensional projection 108 of the three-dimensional model.

In further embodiments, elastic registration may be used to compensate for the rotational and/or shearing offset caused by jitter. In addition, the elastic registration may substantially reduce the lateral and/or longitudinal offset resulting from turbine vibration. Elastic registration involves creating a deformed grid based on the positional differences between certain landmarks on the second transformed image 128 and the two-dimensional projection 108 of the three-dimensional model. The second transformed image 128 may then be mapped to the grid to align the images. As will be appreciated, further alignment techniques, such as rigid registration or thin-plate spline registration, may be employed in alternative embodiments to compensate for turbine vibration, jitter and/or other factors that may result in image misalignment. While the cross-correlation and registration processes described above involve aligning the second transformed image 128 with the two-dimensional projection 108 of the three-dimensional model, it should be appreciated that alternative embodiments may align the second transformed image 128 with a reference image. For example, in certain embodiments, the second transformed image 128 may be aligned with the first transformed image or a two-dimensional projection of the composite model to compensate for the offset between the images, thereby accurately mapping the second transformed image 128 onto the three-dimensional model.

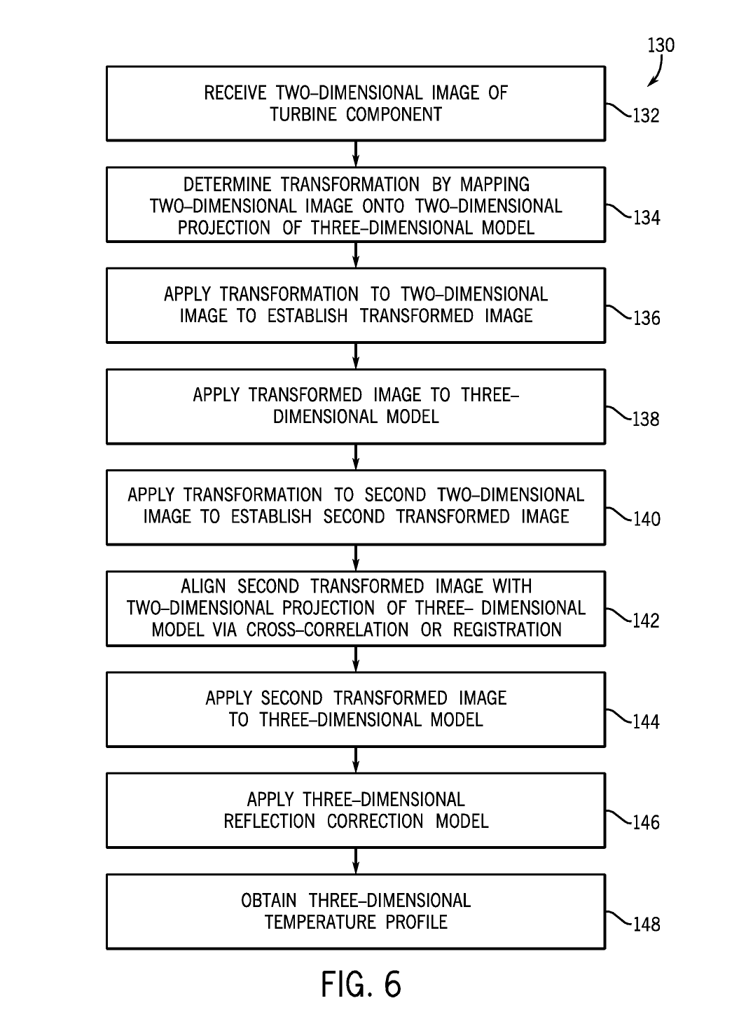

FIG. 6 is a flowchart of a method 130 for mapping a two-dimensional image onto a three-dimensional model. First, as represented by block 132, a two-dimensional image of a turbine component is received. Next, a transformation is determined by mapping the two-dimensional image onto a two-dimensional projection of the three-dimensional model, as represented by block 134. In certain embodiments, the process of determining the transformation includes aligning multiple reference points on the two-dimensional image with corresponding points on the two-dimensional projection of the three-dimensional model, and establishing a bilinear transformation based on the alignment. The transformation is then applied to the two-dimensional image to establish a transformed image, as represented by block 136. Next, as represented by block 138, the transformed image is applied to the three-dimensional model, thereby establishing the composite model. For example, certain embodiments may utilize an inverse perspective transformation to map the transformed image onto the three-dimensional model.

In certain embodiments, the transformation may be applied to a second two-dimensional image to establish a second transformed image, as represented by block 140. The second transformed image is then aligned with the two-dimensional projection of the three-dimensional model via cross-correlation or registration, as represented by block 142. As previously discussed, cross-correlation involves computing a cross-correlation matrix and determining the two-dimensional, linear offset between the images based on the maximum value of the matrix. In certain embodiments, the registration may include elastic registration which involves creating a deformed grid based on the positional differences between certain landmarks on the images and mapping the second transformed image to the grid. Next, as represented by block 144, the second transformed image is applied to the three-dimensional model. This process may be repeated for each image acquired by the imaging system 36. For example, the imaging system 36 may be configured to capture a two-dimensional image of each first stage turbine blade 56 as the blades rotate. The images may then be mapped onto a three-dimensional model of the blade, thereby establishing a composite model for each blade 56 within the turbine 18.

In certain embodiments, a three-dimensional temperature profile may be computed based on the composite model. First, as represented by block 146, the three-dimensional reflection correction model is applied to the composite model. In such a process, the reflected radiation is subtracted from the detected radiation intensity, thereby resulting in a more accurate temperature measurement. Finally, as represented by block 148, the three-dimensional temperature profile is obtained using the projected radiation signal and the correction obtained by the three-dimensional reflection correction model. In this manner, an operator may readily identify temperature variations across the surface of the turbine component.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A system comprising:
a turbine;
a viewing port into the turbine;
a camera in optical communication with the viewing port, wherein the camera is configured to obtain a two-dimensional image of a component within the turbine; and
a controller communicatively coupled to the camera and configured to map the two-dimensional image onto a three-dimensional model of the component to establish a composite model.

2. The system of claim 1, wherein the controller is configured to compute a three-dimensional temperature profile of the component based on the composite model.

3. The system of claim 1, comprising a display communicatively coupled to the controller and configured to display a two-dimensional image of the composite model.

4. The system of claim 1, wherein the camera is optically coupled to the viewing port by a fiber optic cable or an optical waveguide.

5. The system of claim 1, comprising a plurality of viewing ports into the turbine, wherein at least one camera is configured to obtain a two-dimensional image of the component through each viewing port, and the controller is configured to map each two-dimensional image onto the three-dimensional model of the component to establish the composite model.

6. The system of claim 1, wherein the camera is configured to obtain a second two-dimensional image of a second component within the turbine, and the controller is configured to map the second two-dimensional image onto the three-dimensional model of the component via an alignment process.

7. The system of claim 1, wherein the controller is configured to measure a dimensional variation between the component and the three-dimensional model based on the composite model.

8. The system of claim 1, wherein the camera comprises an image sensing device configured to detect infrared wavelengths.

9. The system of claim 1, wherein the camera is configured to obtain the two-dimensional image of the component at an integration time shorter than approximately 10 microseconds.

10. A system comprising:
a turbine comprising a plurality of components in fluid communication with a working fluid; and
an imaging system in optical communication with at least one component of the plurality of components, wherein the imaging system is configured to receive a two-dimensional image of the at least one component during operation of the turbine, and to map the two-dimensional image onto a three-dimensional model of the at least one component to establish a composite model.

11. The system of claim 10, comprising a plurality of viewing ports into the turbine, wherein the imaging system is in optical communication with the at least one component through the plurality of viewing ports, and the imaging system is configured to map a two-dimensional image acquired from each viewing port onto the three-dimensional model of the at least one component to establish the composite model.

12. The system of claim 10, wherein the imaging system is configured to generate a processed image based on the two-dimensional image, the three-dimensional model of the at least one component, or a combination thereof, and to map the processed image onto the three-dimensional model of the at least one component to establish the composite model.

13. The system of claim 10, wherein the imaging system is configured to map a second two-dimensional image onto the three-dimensional model of the at least one component via a cross-correlation or registration process.

14. The system of claim 10, wherein the imaging system is configured to compute a three-dimensional temperature profile of the at least one component based on the composite model.

15. A method comprising:
receiving a two-dimensional image of a turbine component during operation of a turbine; and
mapping the two-dimensional image onto a three-dimensional model of the turbine component to establish a composite model.

16. The method of claim 15, wherein mapping the two-dimensional image onto the three-dimensional model comprises:
determining a transformation by mapping the two-dimensional image onto a two-dimensional projection of the three-dimensional model;
applying the transformation to the two-dimensional image to establish a transformed image; and
applying the transformed image to the three-dimensional model to establish the composite model.

17. The method of claim 16, wherein determining the transformation comprises aligning a plurality of reference points on the two-dimensional image with a corresponding plurality of points on the two-dimensional projection of the three-dimensional model, and determining a transformation based on the alignment.

18. The method of claim 16, wherein applying the transformed image to the three-dimensional model comprises applying an inverse perspective transform to the transformed imaged.

19. The method of claim 16, comprising:
applying the transformation to a second two-dimensional image to establish a second transformed image;
aligning the second transformed image with the two-dimensional projection of the three-dimensional model or a reference image via cross-correlation or registration; and
applying the second transformed image to the three-dimensional model to establish a second composite model.

20. The method of claim 15, comprising:
applying a three-dimensional reflection correction model to the composite model to obtain a three-dimensional temperature correction; and
obtaining a three-dimensional temperature profile based on the three-dimensional temperature correction.
